(19) United States
(12) Patent Application Publication
(10) Pub. No.: US 2023/0019723 A1
(43) Pub. Date: Jan. 19, 2023

(54) INTERACTIVE SUPPLEMENTAL CONTENT SYSTEM

(71) Applicant: Rovi Guides, Inc., San Jose, CA (US)

(72) Inventors: Stephanie M. Adams Ryan, San Francisco, CA (US); Reda Harb, Bellevue, WA (US)

(21) Appl. No.: 17/375,085

(22) Filed: Jul. 14, 2021

(51) Int. Cl. H04N 21/4722; H04N 21/845; H04N 21/81; H04N 21/475

(52) U.S. Cl. CPC H04N 21/4722; H04N 21/8456; H04N 21/8133; H04N 21/4755

(57) ABSTRACT

Systems and methods for generating additional content related to a segment of a content item are disclosed. For example, a system receives a manifest of a first content item where the manifest identifies a plurality of segments of the first content item. The manifest comprises additional content associated with a corresponding segment. The system generates for output a first segment of the plurality of segments on a device. The system receives a user selection requesting the presentation of additional content associated with the first segment. In response to receiving the user selection, the system parses the manifest to request data for the additional content associated with the first segment and generates for output the additional content based on the requested data. Subsequent to generating for output the additional content, the system generates for output the next segment on the device.

### BACKGROUND

With the success or projected success of certain content items, derivative content is generated. For example, when a movie is released, derivative content items or different versions of the content become available, and many content viewers are interested in watching it. But there may be some derivative content that is inappropriate due to the audience's maturity level and the recommended audience level. For example, some deleted scenes of the movie may include highly mature content that did not make it into a final version of the movie screened in theaters because the scenes contain certain content (e.g., sexual content or extreme violence) that was deemed inappropriate for a larger audience.

### SUMMARY

To overcome such issues, methods and systems are described herein for an interactive supplemental content system that provides supplemental content related to a primary content item and presents users real-time options to play supplemental content or restrict playback of any inappropriate supplemental content (e.g., censored content) to non-targeted viewers.

For example, a system receives a request to present a content item (e.g., a movie) for display on a device (e.g., TV). A content item may include a group of sequential scenes. A scene (e.g., car chasing scene) may be a part of a content item in which a unit of an action or an event occurs for a continuous period. The length of the scene may differ based on a content item. In one example, a scene may be over 30 seconds in length. Thus, a 2-hour movie may include 240 30-second scenes. In some embodiments, a scene is made up of one or more segments based on the duration of the scene. The length of the segment may also vary based on a content item. For example, a segment may be a duration of 4 seconds or so. Thus, a 30-second scene may comprise 7 or 8 segments. In another example, a scene and a segment are equal in length (e.g., 3 or 6 seconds). For ease of explanation, a segment may be understood to mean a scene consistent with the present disclosure.

The system may receive a manifest of the content item, and the manifest identifies a plurality of segments of the content item. A manifest may comprise information about additional content (e.g., deleted scenes) for a segment of the plurality of segments of the content item. The system generates for output a first segment of the plurality of segments on the device. The system presents a list of additional content associated with the first segment. The system receives a user selection requesting the presentation of additional content associated with the first segment (e.g., requesting the deleted scenes). In response to receiving the user selection, the system parses the manifest to request data for the additional content associated with the first segment. The system generates for output the additional content based on the requested data. Subsequent to generating for output the additional content associated with the first segment, the system generates for output a second segment that follows the first segment in the plurality of segments of the content item.

In some embodiments, the system enables another device to display a preview of the additional content (e.g., supplemental content). For example, a user may select an option to have the supplemental content sent to another device, different from a device that plays the main content item. Such an embodiment may take place during playback of the main content item at a predetermined time before the upcoming supplemental content is to be played. For example, a family is watching a movie together, and an adult viewer would like to view the preview of the supplemental content before a minor user watches it to determine whether the supplemental content is suitable for the entire family. When user-selectable options for the supplemental content are presented on the main device, the adult viewer may select an option to send a link of specific additional content to the adult viewer's device so the preview may be played on the adult viewer's device rather than the main device that plays the movie.

In one embodiment, the system generates for output a notification on the main device (e.g., TV) when additional content is requested at the main device. In a related embodiment, the system enables a notification to be sent to the adult viewer's device when additional content is requested at the main device. For example, while watching the movie, if additional content is requested, a notification may appear on the adult viewer's device, and the adult viewer may approve or deny the playback of the additional content. If a request is approved, the system queries the database to fetch the additional content based on the manifest associated with the content item to activate playback of the additional content. If a request is denied, the system plays the next segment of the content item. Alternatively, if a minor user is watching a primary content item and seeks to activate the playing of additional content that is deemed inappropriate, a notification may be sent to the adult viewer's device.

While waiting for approval from the adult viewer, the system may generate another content item related to the primary content item on the device. Another content item may be different from the primary content item and may be deemed appropriate to be seen by the entire family. Another content item may be selected based on the user profile data or viewing history stored in a user data source.

In some embodiments, the system replaces an original additional content segment (e.g., additional segment as it is without altering) with a pixelated additional content segment if the additional content includes objectionable content, such as violence, substance abuse, or nudity. For example, when a minor user requests playback of the additional content that includes censored content, the system may replace the original additional content with manipulated additional content so that censored content is not displayed on the main device. Any content manipulation techniques, such as blurring, masking, or pixelating, may be used to generate the pixelated (e.g., obscured) additional content.

In some embodiments, requesting the activating of playback of the additional content may be received via a device (e.g., voice assistant device) that is different from the main device (e.g., TV). For example, a user may provide voice input to select user-selectable options that are presented via a graphical user interface of the main device. A voice input may also be used to select user-selectable options presented via a graphical user interface of the adult viewer's device.

Each scene may be associated with one or more manifest tags representing various supplemental content information. An alternative manifest (e.g., a separate manifest file such as a playlist of additional content) may be created based on available additional content associated with a corresponding scene of a content item. For example, if the supplemental content exists, a manifest of the content item (e.g., original manifest) may reference an alternative manifest file to retrieve corresponding supplemental content. The original manifest may reference the alternative manifest via a Uniform Resource Locator (URL). Alternatively, the original manifest may reference the supplemental content via a URL or a manifest tag. The supplemental content may be retrieved from a respective URL. The alternative manifest file may be stored in a content item database and may be made available to a media application. The manifest may be provided by a content item provider and may be retrieved from a remote source.

A scene of a content item is associated with one or more different types of supplemental content, such as additional subplots, removed scenes, bloopers, director's cut, alternative music scores, inside the episode, bonus content, additional commentary, or extended scenes. This is not an exclusive list and may include other types of supplemental content. Each piece of information may be stored in the manifest in the form of tags. The manifest may be provided by a content item provider and may be retrieved from a remote source.

When a user requests to play all the supplemental content associated with a segment, each supplemental segment may be fetched and consecutively played. If a user requests only a certain type of supplemental content, then only the requested type of supplemental content may be queried by the system. In some embodiments, a user may only request supplemental content associated with a particular scene without watching the particular scene of the content item. Each additional segment in the alternative manifest file may be played after playing a segment of a content item. The following segment may be played after playing the additional content segment.

The present disclosure addresses the problem of accidental viewing of inappropriate content by non-targeted users (e.g., minor viewers), for example, by providing an interactive supplemental content system that prompts real-time user selection that enables either playback of the supplemental content items or restriction of the supplemental content items. The present disclosure further addresses the problems described above by, for example, saving the network bandwidth and reduces network traffic by not sending inappropriate segments of the content item for the purpose of content filtering or by not downloading or streaming segments that did not need to be consumed.

It should be noted that the systems, methods, apparatuses, and/or aspects described above may be applied to, or used in accordance with, other systems, methods, apparatuses, and/or aspects described in this disclosure.

### DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative block diagram of an interactive supplemental content system, in accordance with some embodiments of the disclosure;

FIG. 2 depicts an illustrative block diagram showing additional details of the system of FIG. 1, in accordance with some embodiments of the disclosure;

FIGS. 3A and 3B depict exemplary user interfaces for presenting user-selectable options for presenting supplemental content on the illustrative device, in accordance with some embodiments of the disclosure;

FIG. 4 depicts an exemplary user interface for presenting user-selectable options for presenting supplemental content on the illustrative device, in accordance with some embodiments of the disclosure;

FIG. 5 depicts an exemplary embodiment of providing different ways in which to present the content, in accordance with some embodiments of the disclosure;

FIG. 6 depicts an exemplary embodiment of providing a preview of supplemental content on another device, in accordance with some embodiments of the disclosure;

FIG. 7 depicts an exemplary manifest associated with a content item, in accordance with some embodiments of the disclosure; and

FIG. 8 depicts a flowchart of a process for providing user-selectable options for providing interactive supplemental content, in accordance with some embodiments of the disclosure.

### DETAILED DESCRIPTION

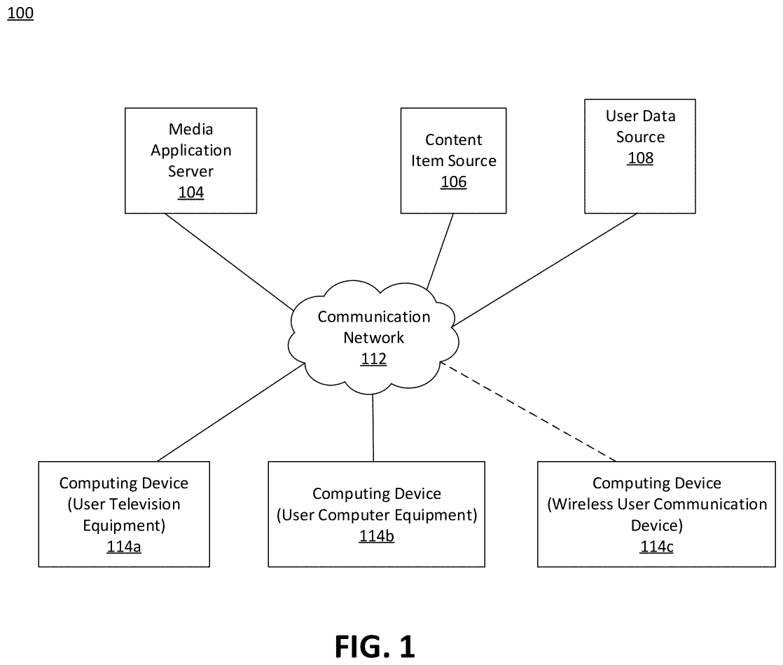

FIG. 1 shows an illustrative block diagram of an interactive supplemental content system, in accordance with some embodiments of the disclosure. In one aspect, system 100 includes one or more of media application server 104, content item source 106, user data source 108, and communication network 112.

Communication network 112 may be one or more networks including the Internet, a mobile phone network, mobile voice or data network (e.g., a 4G or LTE network), cable network, public switched telephone network, or other types of communication network or combinations of communication networks. Communication network 112 includes one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. Communication network 112 communicatively couples various components of system 100 to one another. For instance, server 104 may be communicatively coupled to video-hosting web server, content item source 106, and/or user data source 108 via communication network 112.

Video-hosting web server (not shown) hosts one or more video websites, such as YouTube™, and/or the like, that enable users to download or stream videos, video clips, and/or other types of content. In addition to enabling users to download and view content, the video websites also provide access to data regarding downloaded content.

Content item source 106 may store content item-related data from one or more types of content providers or originator of content (e.g., a television broadcaster, a Webcast provider, on-demand content provider, over-the-top content providers, or other providers of content). Content item source includes a content item, manifest associated with the content item, metadata associated with the content item, or any other related material associated with the content item. The metadata or manifest of the content item may include, among other information of the content item, such as genre information, supplemental content, or parental guidance rating for each segment of the content item. A remote media server may be used to store different types of content in a location remote from computing device 114 (described below). Systems and methods for remote storage of content and providing remotely stored content to user equipment are discussed in greater detail in connection with Ellis et al., U.S. Pat. No. 7,761,892, issued Jul. 20, 2010, which is hereby incorporated by reference herein in its entirety.

User data source 108 may provide user-related data, such as user profile or preference data described herein such as preferred selection options, previous option selection, preferred content item, preferred genre, preferred characters or actors, to computing device 114, server 104 and/or video-hosting web server using any suitable approach. In some embodiments, content item source 106 and user data source 108 may be integrated as one device.

In some embodiments, content item data from content item source 106 may be provided to computing device 114 using a client/server approach. For example, computing device 114 may pull content item data from a server (e.g., server 104), or a server may push content item data to computing device 114. In some embodiments, a client application residing on computing device 114 may initiate sessions with user data source 108 to obtain content item data when needed, e.g., when the content item data is out of date or when computing device 114 receives a request from the user to receive data.

Content and/or content item data delivered to computing device 114 may be over-the-top (OTT) content. OTT content delivery allows Internet-enabled user devices, such as computing device 114, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YouTube™, Netflix™, and HULU™, which provide audio and video via IP packets. YouTube™ is a trademark owned by Google Inc., Netflix™ is a trademark owned by Netflix Inc., and Hulu is a trademark owned by Hulu™. OTT content providers may additionally or alternatively provide content item data described above. In addition to content and/or content item data, providers of OTT content can distribute applications (e.g., web-based applications or cloud-based applications), or the content can be displayed by applications stored on computing device 114.

As described in further detail below, server 104 accesses the content of the video website(s) hosted by video-hosting web server and, based on the accessed content, generates a variety of types of data such as metadata or manifest (e.g., terms, associations between terms and corresponding media content identifiers, genre information, parental guidance ratings, supplemental content for each segment of the content item, and/or the like) that can be accessed to facilitate the retrieving or searching of media content made available by content item source 106. In some embodiments, server 104 accesses a metadata or manifest of the content item from content item source 106. The manifest of the content item may be generated by video-hosting web server or server 104. In some embodiments, the manifest of the content item may be generated by a third-party generator who has access to the content item.

System 100 also includes one or more computing devices 114, such as user television equipment 114a (e.g., a set-top box), user computer equipment 114b, and wireless user communication device 114c (e.g., a smartphone device or a remote control), which users can use to interact with server 104, user data source 108, and/or content item source 106, via communication network 112, to search for desired media content. For instance, in some aspects, server 104 may provide a user interface via computing device 114, by which a user can input a query for a particular item of media content made available by content item source 106, and generate a response to the query by accessing and/or processing data and/or manifest. Although FIG. 1 shows one of each component, in various examples, system 100 may include multiples of one or more illustrated components. For instance, system 100 may include multiple video-hosting web servers and server 104 may aggregate data from the multiple video websites hosted by multiple video-hosting web servers, respectively.

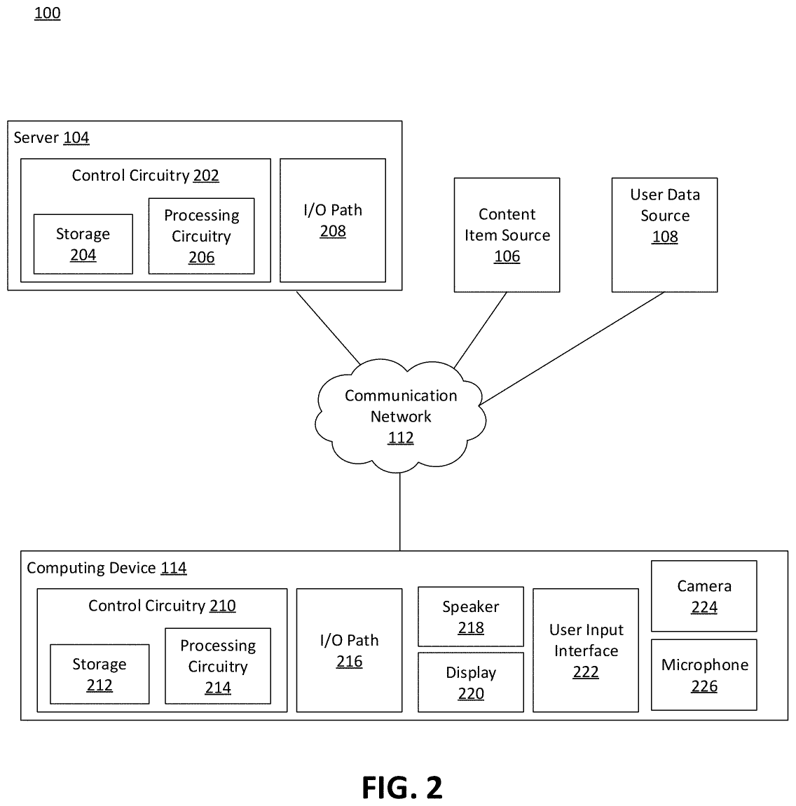

FIG. 2 is an illustrative block diagram showing additional details of the system 100 of FIG. 1, in accordance with some embodiments of the disclosure. In particular, server 104 includes control circuitry 202 and Input/Output (I/O) path 208, and control circuitry 202 includes storage 204 and processing circuitry 206. Computing device 114 includes control circuitry 210, I/O path 216, speaker 218, display 220, camera 224, microphone 226, and user input interface 222. Control circuitry 210 includes storage 212 and processing circuitry 214. Control circuitry 202 and/or 210 may be based on any suitable processing circuitry such as processing circuitry 206 and/or 214.

As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 204, storage 212, and/or storages of other components of system 100 (e.g., storages of content item source 106, user data source 108, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Each of storage 204, storage 212, and/or storages of other components of system 100 may be used to store various types of content, content item data, and or other types of data. Non-volatile memory may also be used (e.g., to launch a boot-up routine and other instructions). Cloud-based storage may be used to supplement storages 204, 212 or instead of storages 204, 212.

In some embodiments, control circuitry 202 and/or 210 executes instructions for an application stored in memory (e.g., storage 204 and/or 212). Specifically, control circuitry 202 and/or 210 may be instructed by the application to perform the functions discussed herein. In some implementations, any action performed by control circuitry 202 and/or 210 may be based on instructions received from the application. For example, the application may be implemented as software or a set of executable instructions that may be stored in storage 204 and/or 212 and executed by control circuitry 202 and/or 210. In some embodiments, the application may be a client/server application where only a client application resides on computing device 114, and a server application resides on server 104.

The application (e.g., media application) may be implemented using any suitable architecture. For example, it may be a stand-alone application wholly implemented on computing device 114. For example, the media application may be implemented as software or a set of executable instructions, which may be stored in non-transitory storage 212 and executed by control circuitry 210 of a user device 114. In such an approach, instructions for the application are stored locally (e.g., in storage 212), and data for use by the application is downloaded on a periodic basis (e.g., from an out-of-band feed, from an Internet resource, or using another suitable approach). Control circuitry 210 may retrieve instructions for the application from storage 212 and process the instructions to perform the functionality described herein. Based on the processed instructions, control circuitry 210 may determine what action to perform when input is received from user input interface 222.

In client/server-based embodiments, control circuitry 210 may include communication circuitry suitable for communicating with an application server (e.g., server 104) or other networks or servers. The instructions for carrying out the functionality described herein may be stored on the application server. Communication circuitry may include a cable modem, an integrated services digital network (ISDN) modem, a digital subscriber line (DSL) modem, a telephone modem, an Ethernet card, or a wireless modem for communication with other equipment, or any other suitable communication circuitry. Such communication may involve the Internet or any other suitable communication networks or paths (e.g., communication network 112).

In another example of a client/server-based application, control circuitry 210 runs a web browser that interprets web pages provided by a remote server (e.g., server 104). For example, the remote server may store the instructions for the application in a storage device. The remote server may process the stored instructions using circuitry (e.g., control circuitry 202) and generate the displays discussed above and below. Computing device 114 may receive the displays generated by the remote server and may display the content of the displays locally via display 220. This way, the processing of the instructions is performed remotely (e.g., by server 104) while the resulting displays are provided locally on computing device 114. Computing device 114 may receive inputs from the user via input interface 222 and transmit those inputs to the remote server for processing and generating the corresponding displays.

A user may send instructions to control circuitry 202 and/or 210 using user input interface 222. User input interface 222 may be any suitable user interface, such as a remote control, trackball, keypad, keyboard, touchscreen, touchpad, stylus input, joystick, voice recognition interface, or other user input interfaces. User input interface 222 may be integrated with or combined with display 220, which may be a monitor, a television, a liquid crystal display (LCD), electronic ink display, or any other equipment suitable for displaying visual images.

Camera 224 of computing device 114 may capture an image or a video. A microphone 226 of computing device 114 may detect sound in proximity to computing device 114 and converts the sound to electrical signals.

Server 104 and computing device 114 may receive content and data via I/O paths 208 and 216, respectively. I/O paths 208, 216 may provide content (e.g., broadcast programming, on-demand programming, Internet content, content available over a local area network (LAN) or wide area network (WAN), and/or other content) and data to control circuitry 202, 210. Control circuitry 202, 210 may be used to send and receive commands, requests, and other suitable data using I/O paths 208, 216. I/O paths 208, 216 may connect control circuitry 202, 210 (and specifically processing circuitry 206, 214) to one or more communication paths (described below). I/O functions may be provided by one or more of these communication paths but are shown as single paths in FIG. 2 to avoid overcomplicating the drawing.

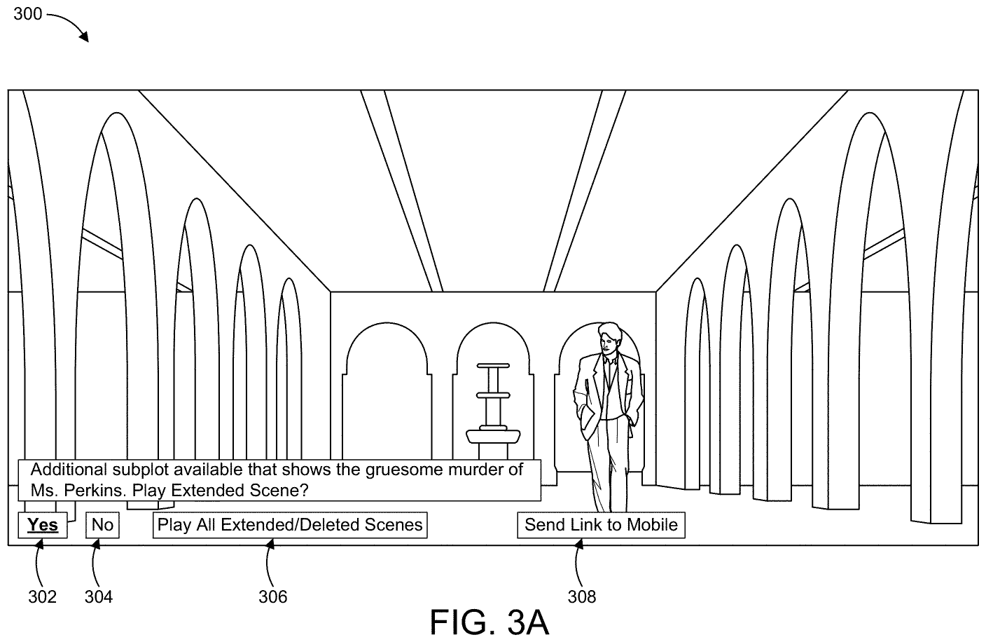

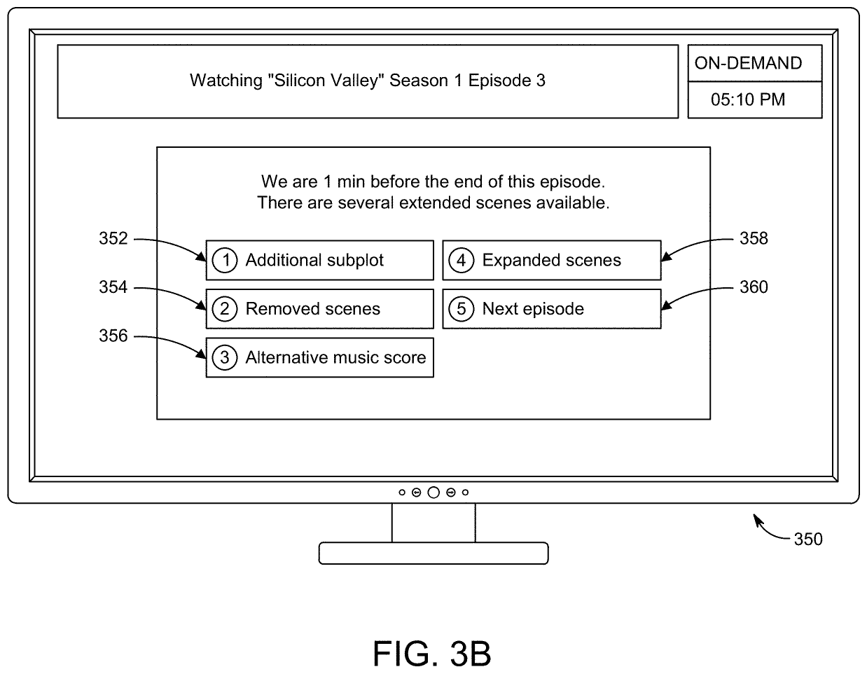

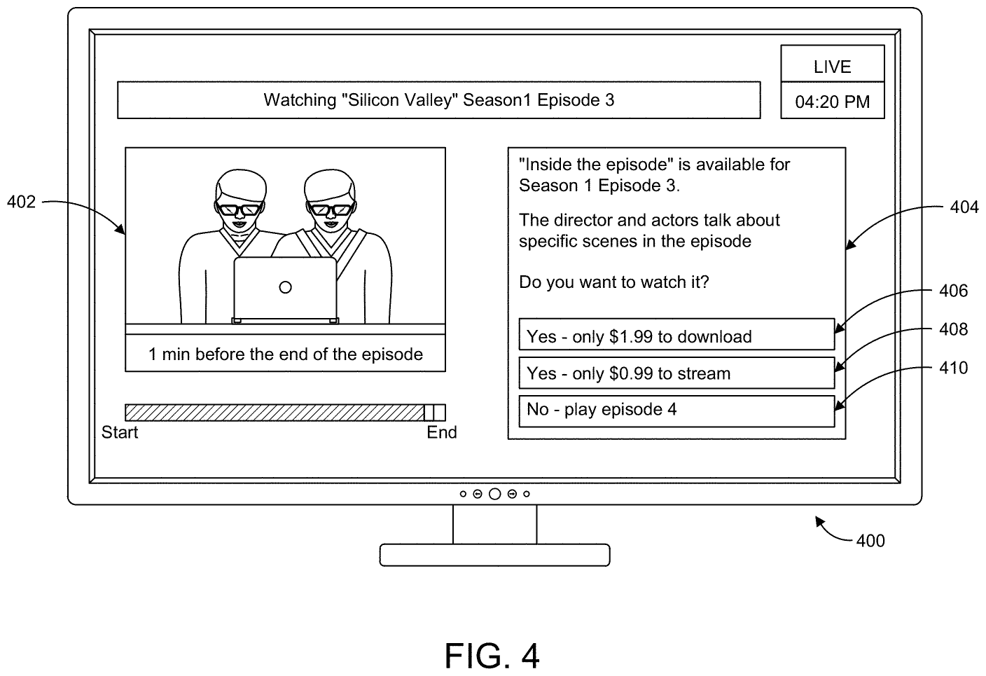

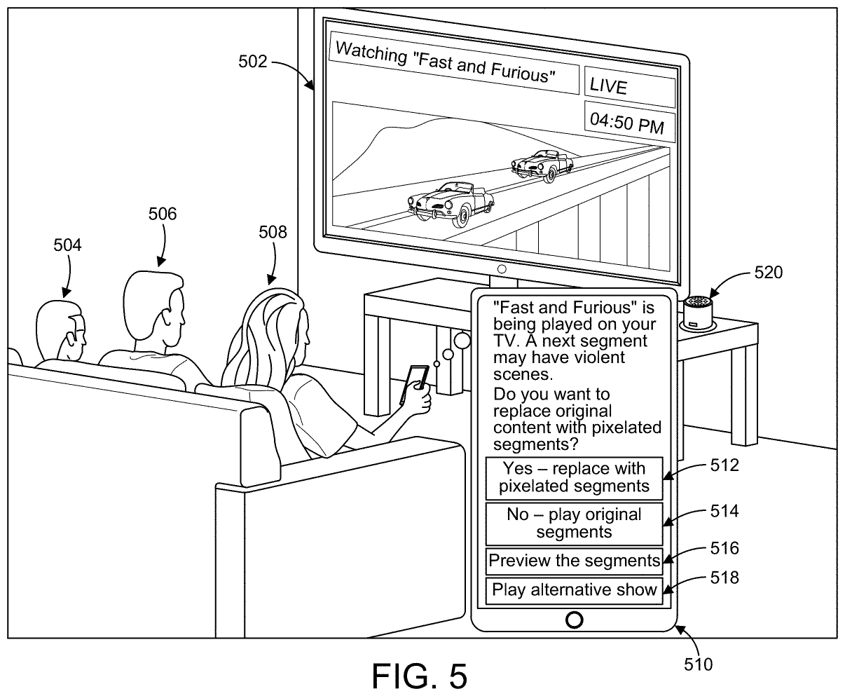

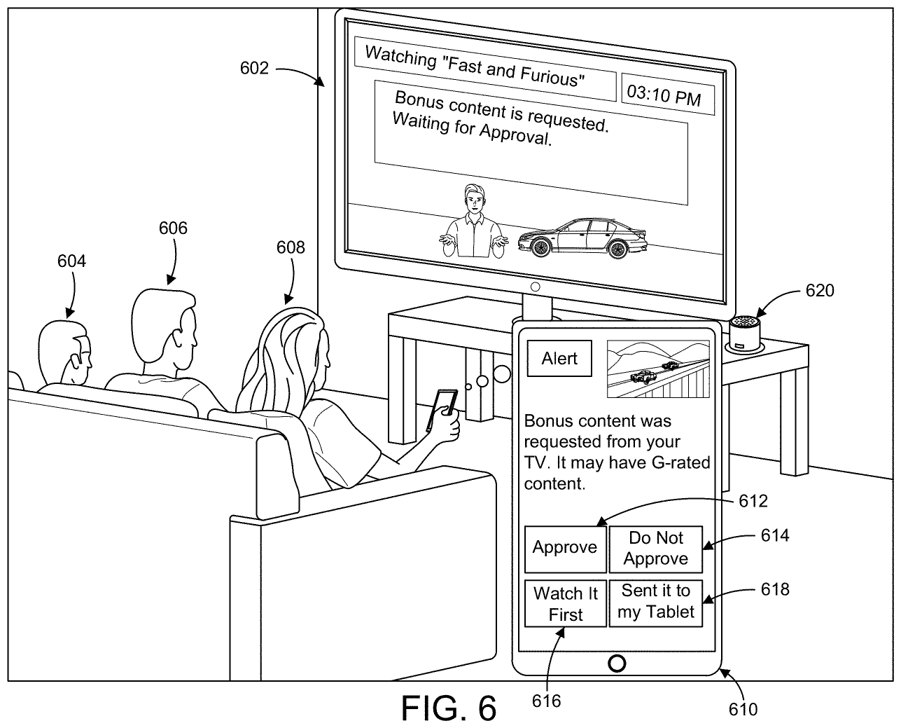

Having described system 100, reference is now made to FIG. 3A, which depicts an example user interface 300 for presenting additional content on the illustrative device 114 that may be implemented using system 100, in accordance with some embodiments of the disclosure. Reference is also made to FIG. 3B, FIG. 4, FIG. 5, and FIG. 6, which show example user interfaces 350, 400, 510, and 610 generated by system 100, in accordance with some embodiments. Although FIGS. 3A-6 depict a user device (e.g., display device) as a television, it will be understood that any suitable device for displaying video content may be used, such as gaming equipment, user computer equipment, or a wireless user communications device discussed above in relation to FIG. 1.

The user device may have a media application implemented on computing device 114 configured to request a content item from a server for display. It will be understood that, consistent with the present disclosure, any content item may be requested for streaming or downloading from server 104 or a video-hosting web server.

The content item may include a group of sequential scenes. The length of the scene may differ based on a content item. In one example, a scene is over 30 seconds in length. Thus, a 2-hour movie may include 240 30-second scenes. In some embodiments, a scene is made up of one or more segments based on the duration of the scene. The length of the segment may also vary based on a content item. In one example, a segment may be a duration of 4 seconds or so. Thus, a 30-second scene may comprise 7 or 8 segments. In some embodiments, it should be understood that, consistent with the present disclosure, a segment means a scene. In some embodiments, a segment may consist of one or more frames. In some embodiments, a frame is one of the many still images.

As referred to herein, the term “content item” should be understood to mean an electronically consumable user asset, such as an electronic version of a printed book, electronic television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, articles, newspapers, blogs, advertisements, chat sessions, social media, applications, games, and/or any other media or multimedia and/or combination of the same.

When a user requests presentation of a content item (e.g., movie) on computing device (e.g., TV or laptop) 114 via the media application implemented on device 114, the media application requests the content item from a video-hosting web server or server 104. In response to the request, the server sends a manifest of the content item. The manifest may contain information about sequential scenes or segments of the content item, for example, the timing of each scene (or segment), or genre information for each scene (or segment) of the content item.

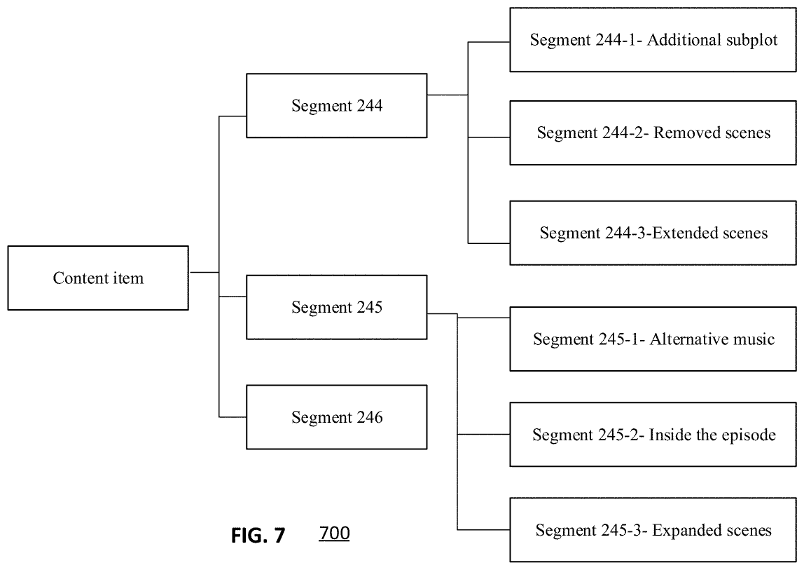

In some embodiments, an alternative manifest that includes information about supplemental content of a content item is generated. FIG. 7 depicts a block diagram of exemplary manifest 700, including information about supplemental content associated with a corresponding scene or segment, in accordance with some embodiments of the disclosure. A scene of the content item may be associated with one or more manifest tags representing various supplemental content information related to the scene. As shown in exemplary manifest 700, an alternative manifest may be created based on available additional content associated with a corresponding segment of a content item. Although FIG. 7 is illustrated in the context of segments, it should be understood that a segment may be interpreted as a scene in some instances.

For example, segment 244 is associated with three supplemental content types: 1) segment 244-1: additional subplot; 2) segment 244-2: removed scenes; and 3) segment 244-3: extended scenes. When a user requests to play all of the additional content associated with segment 244, each segment 244-1, 244-2, or 244-3 may be consecutively played. If a user requests only a certain type of additional content (e.g., 244-2), then only the removed scenes may be queried. Segments 244-1, 244-2, or 244-3 in the alternative manifest file may be played after playing an original segment 244 of a content item. Segment 245 may be played after playing the additional segment 244-N.

During playback of a movie, the media application utilizes the available manifest(s) associated with a movie to make a determination of whether supplemental content exists for the movie. If a supplemental manifest file exists, then the manifest file(s) is made available to the media application, and the user-selectable options are generated accordingly. The media application queries content item data source 106 to retrieve supplemental content. During playback of the content via a media application, if supplemental content is available, the user is presented with a prompt that informs the user that supplemental content is available and upcoming. If a user makes a selection to view the supplemental content, a manifest-alternating logic may be activated. For example, the original manifest or playlist for the main content may reference the supplemental manifest (e.g., via a URL) or reference the supplemental content (e.g., via a tag) to retrieve corresponding supplemental content. Once the corresponding supplemental content is presented, the media application may utilize the original manifest to present a following segment of the content item.

As shown in exemplary user interface 300, the prompt (“Additional subplot available that shows the gruesome murder of Ms. Perkins. Play extended scene?”) is presented to the user with user-selectable options 302, 304, 306, 308. The user may accept by selecting a “Yes” option 302. If “Yes” option 302 is selected, then the alternative manifest is utilized to retrieve data for the requested subplot. The user may deny by selecting a “No” option 304. If the “No” option is selected, the media application plays the next segment of the movie. The default can be “No” (e.g., skip) when a response is not explicitly received, and as such, the segments are marked with a “Default: No” tag, and the supplemental content will not be played. Another option can also include “Play all extended/deleted scenes” option 306. Acceptance of option 306 activates the playback of all the available extended or deleted scenes associated with a currently displayed segment of the movie. In some embodiments, the user may indicate to send the supplemental content to another device by selecting “Send link to mobile” option 308. This option will be explained in connection with FIG. 5.

FIG. 3B is an exemplary user interface 350 showing different types of supplemental content. Supplemental content can be any content that is related to a segment of the content item that is made available by a content provider or a third-party provider. For example, before the end of an episode, a media application parses the manifest to determine whether there is any available supplemental content that is related to episode 3 of “Silicon Valley.” Some information in the form of manifest can be presented with a prompt to indicate what the supplemental content constitutes additional subplot 352, removed scenes 354 (e.g., due to extreme violence), altered music score 356, expanded scenes related to an event that already occurred 358 (e.g., a character remembering crime that he or she witnessed, etc.). This allows a viewer to confirm what additional content to play outside of the original content. The list is not an exclusive list and may include other types of supplemental content.

For example, extended or deleted scenes are normally part of the rising action or climax portion of the movie, such as a confrontation or resolution phase of the movie. The extended or deleted scenes may be different versions of the event that did not make it to a final version of a content item due to various reasons, but watching them may help learn the director's intent in making the scenes. In some embodiments, the supplemental content may be different from the “theatrical cut” or “director's cut” available on a DVD of the content item.

In some embodiments, soundtracks can be replaced using any sound-altering techniques. For example, different soundtracks (e.g., background music) can be replaced while the video content remains the same. In a related example, altered musical scores may have special music effects applied to the original soundtrack. By way of other examples, the alternative soundtrack can contain explicit language that was edited out of the original soundtrack. Similarly, the alternative background music can be a different genre than what's present in the original content. It is common for content items with a dubbed dialogue to include background music in the original language that was used during production. The audio can also be replaced to match the dubbed language.

In one embodiment, the supplemental content is maintained by a third-party service, such as a dedicated service that is contracted to manage supplemental or bonus content on behalf of a content provider. This service is directly accessible by the “playback service” of any video service such as OTT applications and VOD platforms. Creating the additional content manifest depends on the original manifest associated with a particular OTT service. Different services pre-process their content in different ways, such as using different codecs, segments with differing lengths (e.g., 5 seconds vs. 9 seconds), and different streaming protocols, etc. In such scenarios, the delta in the time difference between the segments is relied upon for accurate encoding and supplemental manifest creation. The third-party service can also act as “another” content delivery network such that the media application retrieves only segments belonging to supplemental content from it and relies on the content delivery network associated with the video service to play the original content. It is important to note that the media application may request supplemental content at different bit rates to support adaptive streaming than it does when requesting the primary content (e.g., movie).

As shown in FIG. 3B, the prompt may be presented to the user at a pre-specified time (e.g., 1 minute before the end of the segment), indicating that the supplemental content is upcoming. The prompt may be presented at any time during the main content item. The prompt may be presented enough in advance that the viewers can decide on whether to watch the supplemental content related to the currently displayed episode before moving on to the next scene, next segment, or next episode. Thus, a user may consume the supplemental content at any time during playback of the main content item and does not have to wait until the end of the main content item to watch the supplemental content that is related to a particular segment or scene. The pre-specified time may be changed by a user. If a user does not wish to view any supplemental content, then a user may select to play the next episode 360.

In some embodiments, preferred user selections are stored in user data source 108. The preferred user selections may include any type of selection a user makes related to the supplemental content. For example, preferred user selections include a type of supplemental content that a user watches frequently (e.g., removed scenes over additional subplot), a user-selectable option available for the supplemental content (e.g., streaming the supplemental content over downloading the supplemental content), or a user-selectable option for responding to a request for playing of a certain segment of a content item (e.g., approving of playback of a violent segment of the movie). Based on the preferred user selections, the media application automatically selects a corresponding user-selectable option available for the supplemental content or a content item or plays a corresponding supplemental content without receiving a user input specifying the selection.

FIG. 4 depicts exemplary user interface 400 for presenting user-selectable options for supplemental content on the illustrative device, in accordance with some embodiments of the disclosure. Many content items offer “inside the episode” content where a content author, director, or actors/actresses talk about specific scenes in the episode. “Inside the episode” content normally replays a segment or scene that the director wishes to talk about and includes commentary associated with the scene. This type of additional content is available at the end of a corresponding scene or the end of the episode and could be part of the same media file or part of a separate file. “Inside the episode” supplemental content may be watched right after the scene that it relates to in the main content item. As shown in FIG. 4, a user is prompted to watch a segment in the “inside the episode” that relates to a particular scene in the original content item (e.g., “Silicon Valley” season 1 episode 3) that was just consumed (e.g., the last scene in this example). Although the last scene of the content item was used for illustration purposes, “the inside the episode” may be available for any scene in the content item and may be played during the main content item. The media application makes such a determination if the “inside the episode” content is referenced in the manifest file by determining a current episode number and scene number and determining whether the manifest includes the “inside the episode” tag associated with the current episode and the current scene. Alternatively, the media application may make such a determination if the “inside the episode” is referenced in the manifest file by determining whether duplicate segments (e.g., same segment number) are present in the referenced manifest. In some embodiments, image processing is utilized to detect repeated segments or scenes because “Inside the episode” supplemental content normally replays the segment or scene (that was just consumed) that the director wishes to talk about. If the “inside the episode” content exists, a manifest file associated with the content item may be used to retrieve the “inside the episode” additional content.

As shown in FIG. 4, exemplary user interface 400 includes a prompt 404 that indicates that the “inside the episode” is available for season 1, episode 3, scene 42 of the “Silicon Valley” show. Prompt 404 may be presented before the end of the currently displayed episode 402 in a Picture-In-Picture (PIP) or a separate window. Prompt 404 may be presented with one or more user-selectable options associated with the different presentation modes available for the “inside the episode.” For example, user-selectable option 406 is available for downloading the “inside the episode,” and user-selectable option 408 is available for streaming the “inside the episode.” If a user does not wish to view the “inside the episode,” then the user may simply select the “No” option 410 to proceed to the next episode. Although the “inside the episode” type of additional content was used herein for illustration purposes, it will be understood that any type of additional content may be used.

In some embodiments, the options may be presented through linear TV channels offered as shown in exemplary user interface 350 or on-demand programs as shown in exemplary user interface 400. For example, a user may start viewing a movie through a live TV service (e.g., cable TV), and a session may be switched to on-demand once a user requests playback of supplemental content. The options may be presented in real time and automatically without receiving any user input.

FIG. 5 depicts an exemplary user interface 500 for providing different ways in which to present a content item, in accordance with some embodiments of the disclosure. As shown in FIG. 5, a family 504, 506, 508 is watching a live content item 502 (e.g., “Fast and Furious” movie) together. While watching the movie (e.g., segment 3 of the movie), a media application determines that the next segment (e.g., segment 4) includes violent scenes that may be inappropriate for a minor user 504. The media application may parse the metadata or manifest of the movie, which may include genre information or parental guidance rating information, and determine that segment 4 includes violent scenes. The media application may transmit a notification to an adult viewer's device separate from the main device (e.g., TV) on which the movie is being displayed.

As shown in exemplary user interface 510, a warning message may be displayed on an adult viewer's device to indicate that the next segment includes scenes that the user may deem inappropriate. The warning message may be presented with one or more user-selectable options to present a content item: option 512 includes replacing segment 4 with pixelated segments; option 514 includes playing the original segment 4 (e.g., the main content item as it is without altering the segment); option 516 includes playback of a preview of segment 4 on the adult viewer's device before playing segment 4 on the TV; and option 518 includes playing an alternative show that is related to the currently displayed show and that is deemed appropriate for the entire family. In some embodiments, the warning message and user-selectable options are displayed on the main device (e.g., TV) that plays the content item. The supplemental content of a pixelated segment may be retrieved from a remote data source or may be generated by the media application. In some embodiments, a pixelated segment is generated by applying or inserting a filter to a segment of the content item. Any image filtering techniques may be used to generate a pixelated segment. Exemplary user interface 510 may include an option to skip a corresponding segment (e.g., violent segment) and plays a following segment of the content item (not shown).

Additionally, the media application may automatically activate a voice assistant on the device 520 (e.g., smart speaker in the vicinity) that is linked to the playback device (e.g., TV) to collect a viewer's feedback. For example, adult user 508 may provide voice input to voice assistant device 520 to select user-selectable options that are presented via a graphical user interface of the adult user's device.

FIG. 6 depicts an exemplary embodiment 600 of providing a preview of supplemental content on another device, in accordance with some embodiments of the disclosure. As shown in FIG. 6, a family 604, 606, 608 is watching a content item 602 (e.g., “Fast and Furious” on-demand movie). During the playback of the movie, any of the viewers may request additional content of the movie via a media application that is used to play the movie on the TV. The request may be made via any input-providing mechanism. In some embodiments, requesting the playback of the additional content may be received via a device 620 (e.g., voice assistant device) that is different from the main device (e.g., TV). For example, a minor user may request additional content via voice assistant device 620 by providing voice input (e.g., by saying “Show me bonus content of the movie.”)

When a request is received, a notification may be displayed on an adult viewer's device as shown in exemplary user interface 610 on the adult viewer's device. The notification includes a message that the bonus content was requested by the main device. The notification may include one or more user-selectable options for responding to the request. For example, option 612 includes approving playback of the additional content on the TV; option 614 includes denying playback of the additional content; option 616 includes playback of the additional content; and option 618 includes sending a link to the additional content to another device associated with the adult viewer's device (e.g., tablet). When a user selection is received, an action corresponding to the selection is performed.

While a request is being evaluated by the adult viewer (e.g., viewing a preview), a different content item (e.g., advertisement) may be shown on the main playback device prior to displaying the bonus content. For example, automobile-related advertisements that are related to the movie (e.g., car racing movie) may be shown on the main playback device to entice the user to become interested in a product that is often shown in the movie. In another example, advertisements related to the movie offered from other networks or services that the user is not subscribed to can be shown to entice the user to subscribe or expand their existing video-on-demand programs. (e.g., another network that plays “Fast and Furious 2”).

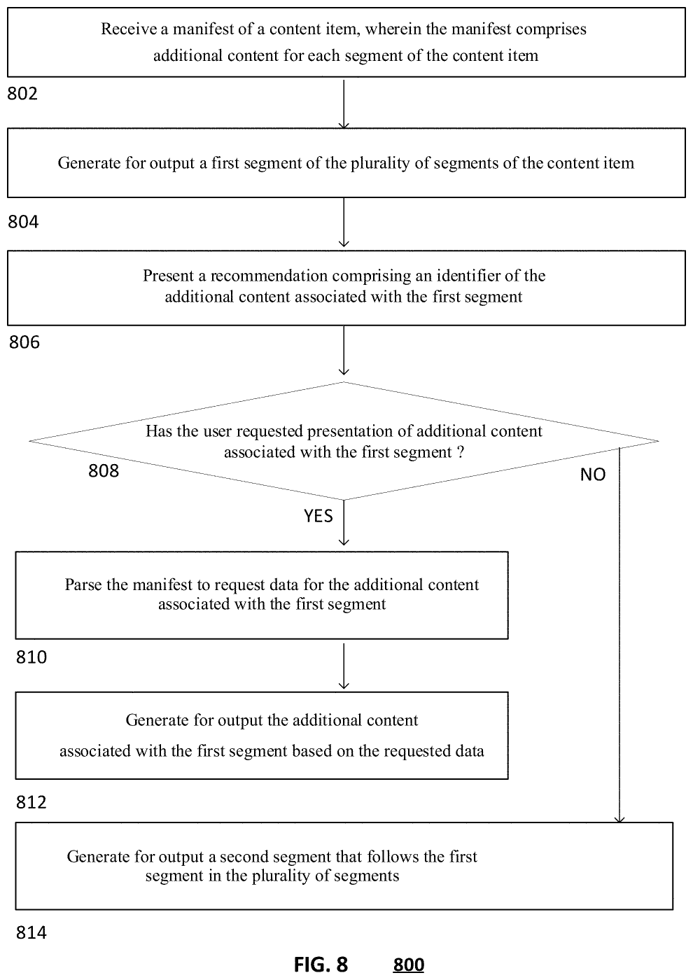

FIG. 8 depicts a flowchart of a process 800 for providing supplemental content, in accordance with some embodiments of the disclosure. It should be noted that process 800 may be performed by control circuitry 202, 210 of FIG. 2 as instructed by a media application that may be performed on any device 114 of FIG. 2. In addition, one or more steps of process 800 may be incorporated into or combined with one or more embodiments (e.g., user interfaces 300, 350, 400, 500, 600 of FIGS. 3A-6). Process 800 may be performed in accordance with the components discussed in connection with FIGS. 1-2.

At step 802, control circuitry 210 receives a manifest of a content item, where the manifest comprises additional content (e.g., supplemental content) for each segment of the content item, such as deleted scenes or expanded scenes associated with the content item. The content item consists of one or more sequential segments, where each segment is associated with one or more manifest tags identifying one or more available supplemental content items. At step 804, control circuitry 210 generates a first segment of a plurality of segments of a content item for output.

At step 806, control circuitry 210 presents a recommendation comprising an identifier of the additional content associated with the first segment as shown in exemplary user interface 350 of FIG. 3B. At step 808, control circuitry 210 determines whether a user requests the presentation of additional content associated with the first segment. If a request was not made, at step 814, control circuitry 210 generates the second segment for output on illustrative device 114 without presenting the additional content. If a request is made, at step 810, control circuitry 210 parses the manifest to request data for additional content associated with the first segment. At step 812, control circuitry 210 generates for output the additional content associated with the first segment. Subsequent to generating the additional content for output, at step 814, control circuitry 210 generates the second segment for output on illustrative device 114.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving a manifest of a first content item, wherein the manifest identifies a plurality of segments of the first content item,
wherein the manifest comprises additional content associated with a corresponding segment of the plurality of segments of the first content item;
generating for output a first segment of the plurality of segments on a first device;
receiving a user selection requesting presentation of additional content associated with the first segment;
in response to receiving the user selection:
generating an alternative manifest based on the user selection requesting presentation of the additional content associated with the first segment;
parsing the alternative manifest to request data for the additional content associated with the first segment;
generating for output the additional content associated with the first segment based on the requested data;
subsequent to generating for output the additional content associated with the first segment, generating for output a second segment on the first device, wherein the second segment follows the first segment in the plurality of segments of the first content item; and
generating a selectable link for display of the additional content on a second device different from the first device.

2. The method of claim 1, further comprising:
generating for output a recommendation comprising an identifier of the additional content associated with the first segment of the first content item.

3. The method of claim 1, wherein the additional content includes at least one of additional subplot, extended scenes, expanded scenes, inside the episode, bloopers, director's cut, bonus content, alternative music score, or removed scenes.

4. The method of claim 1, wherein the additional content is not part of the first content item.

5. The method of claim 1, further comprising:
generating for output a user input prompting to respond whether to approve the additional content to be displayed on the first device;
receiving the user input approving the additional content to be displayed on the first device; and
while waiting for the user input to be received, generating for output a second content item related to the first content item on the first device.

6. The method of claim 1, further comprising:
in response to selection of the selectable link for display of the additional content on the second device, sending a link to the additional content to the second device.

7. The method of claim 1, wherein the user selection requesting presentation of additional content associated with the first segment is received at a third the second device different from the first device.

8. The method of claim 1, further comprising:
determining that the second segment includes a portion that is deemed inappropriate;
presenting a user-selectable option to replace the second segment with a particular segment; and
in response to receiving an input selecting the option, replacing the second segment with the particular segment.

9. The method of claim 1, wherein the additional content is requested at a bit rate different from a bit rate at which the first segment was requested.

10. The method of claim 1, wherein the first content item is generated for output in real time.

11. A system comprising:
control circuitry configured to:
receive a manifest of a first content item, wherein the manifest identifies a plurality of segments of the first content item,
wherein the manifest comprises additional content associated with a corresponding segment of the plurality of segments of the first content item;
generate for output a first segment of the plurality of segments on a first device;
receive a user selection requesting presentation of additional content associated with the first segment;
in response to receiving the user selection:
generate an alternative manifest based on the user selection requesting presentation of the additional content associated with the first segment;
parse the alternative manifest to request data for the additional content associated with the first segment;
generate for output the additional content associated with the first segment based on the requested data;
subsequent to generating for output the additional content associated with the first segment, generate for output a second segment on the first device, wherein the second segment follows the first segment in the plurality of segments of the first content item; and
generate a selectable link for display of the additional content on a second device different from the first device.

12. The system of claim 11, wherein the control circuitry is further configured to:
generate for output a recommendation comprising an identifier of the additional content associated with the first content item.

13. The system of claim 11, wherein the additional content includes at least one of additional subplot, extended scenes, expanded scenes, bloopers, director's cut, inside the episode, bonus content, alternative music score, or removed scenes.

14. The system of claim 11, wherein the additional content is not part of the first content item.

15. The system of claim 11, wherein the control circuitry is further configured to:
generate for output a user input prompting to respond whether to approve the additional content to be displayed on the first device;
receive the user input approving the additional content to be displayed on the first device; and
while waiting for the user input to be received, generate for output a second content item related to the first content item on the first device.

16. The system of claim 11, wherein the control circuitry is further configured to:
in response to selection of the selectable link for display of the additional content on the second device, send a link to the additional content to the second device.

17. The system of claim 11, wherein the user selection requesting presentation of additional content associated with the first segment is received at a third the second device different from the first device.

18. The system of claim 11, wherein the control circuitry is further configured to:
determine that the second segment includes a portion that is deemed inappropriate;
present a user-selectable option to replace the second segment with a particular segment; and
in response to receiving an input selecting the option, replace the second segment with the particular segment.

19. The system of claim 11, wherein the additional content is requested at a bit rate different from a bit rate at which the first segment was requested.

20. The system of claim 11, wherein the first content item is generated for output in real time.
